(19) United States
(12) Patent Application Publication
(10) Pub. No.: US 2009/0187818 A1
(43) Pub. Date: Jul. 23, 2009

(54) METHOD AND SYSTEM OF INTERFACE COMMENT MAPPING

(75) Inventors: Matthew C. Compton, Tucson, AZ (US); Louis D. Echevarria, Tucson, AZ (US); Michael R. Maletich, Tucson, AZ (US); Richard A. Welp, Tucson, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/017,648

(22) Filed: Jan. 22, 2008

(51) Int. Cl. G06F 17/00

(52) U.S. Cl. 715/234

(57) ABSTRACT

Tracking web page comments on a computer includes storing comments on the web page and rendering the stored comments on a next draft site web page, in accordance with comment tracking policies. The comment tracking is accomplished by storing comments on the web page, upon receiving a uniform resource locator to a draft site, then loading the draft web site into an inline frame object on an application web site and loading content of the draft web site into a portion of the application web site. After loading the content, comments are drawn on a z-layer on top of a page of the drawn draft web site, by the application web site, using a scripting language; implemented by the application web site, in accordance with stored comment tracking policies. The scripting language comments and their memory locations are transmitted back to the network server.

### TECHNICAL FIELD

The present invention relates to software development, testing and documentation. More particularly, the present invention relates to Internet based software design tools for efficiently tracking web page comments.

### BACKGROUND

Known methods and systems for tracking text based web page comments, such as comments in regard to test and development bugs using databases provides for quick searching, but searching for bugs in visual interfaces and graphical user interfaces is more difficult, because searching for bugs in visual interfaces cannot be easily accomplished using search techniques suited for text searches.

Therefore, the need exists for a method and system of tracking web page comments using visual and graphical user interfaces, thus allowing the defects to be referenced on the web page in the interface.

### SUMMARY OF THE INVENTION

A method and system are disclosed herein for tracking web page comments using visual and graphical user interfaces. The tracking of web page comments can involve an initial web site design phase, as well as a final review phase, which can further include making editorial remarks, as well as, including notations about web page development bugs. The tracking can also be used by students to draft comments on a web page that they are browsing to identify research topics for a school research paper. The tracking of web page comments can further be used in interactive social networking web sites, an example of which is MYSPACE to allow people to make free-hand comments on a page instead of just adding comments to a database. Ultimately, the tracking of web page comments capability can be a web plug in tool that gives people the freedom to make comments and add content to web pages. The tracking is accomplished by storing comments on a web page and rendering the stored comments on a next draft site web page, in accordance with stored comment tracking policies, when the next draft site web page is loaded. Thus, there are two web applications one that is managing the comments (i.e., the application site) and one that is being commented on (i.e., the draft site). These two applications may or may not be on the same machine or the same application. The application site may run on the users local client side machine. Storing the comments on the web page can include receiving a log on request to an application web site from a local user computer. After receiving the log on request, then logging the local user computer onto the application web site. After logging the local user computer onto the application web site, receiving a uniform resource locator for a draft site, where the uniform resource locator is input from an input device on the local user computer, and where the draft web site includes a plurality of web page content. The draft web site is loaded into an inline frame object on the application web site and the content of the draft web site is loaded into a portion of the application web site. In general, web page comment tracking implementations involve comments input on a z-layer on top of a page of the drawn draft web site, by the application web site, using a prototype-based scripting language or program for web development. Examples of such an implementation can include but are not limited to comments made by students marking up a web page for research projects or individuals browsing interactive social networking web pages or web page test and development comments about known bugs. No matter what the implementation is, the comments are inputted on a z-layer on top of a page of the drawn draft web site, by the application web site, using but not limited to JavaScript on any other scripting language or program, implemented by the application web site; and the comments are submitted back to a server or any number of servers or any number of client side devices or via an application focused on a server as a series of HTTP transactions initiated by a client side script or plugin for a web browser such as, but not limited to FIREFOX, and then rendered in the next draft web page. In addition, the implementation can be run on a third party application on a desktop involving databases where the current application is synchronized with other databases or run locally. In addition, the application web site has a persistent backup storage capability for storing each comment including text, pixel location and web address and each comment is summarized by an address.

The above-described and other features will be appreciated and understood by those skilled in the art from the following detailed description, drawings, and appended claims.

### DETAILED DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings, which are meant to be exemplary, and not limiting, wherein:

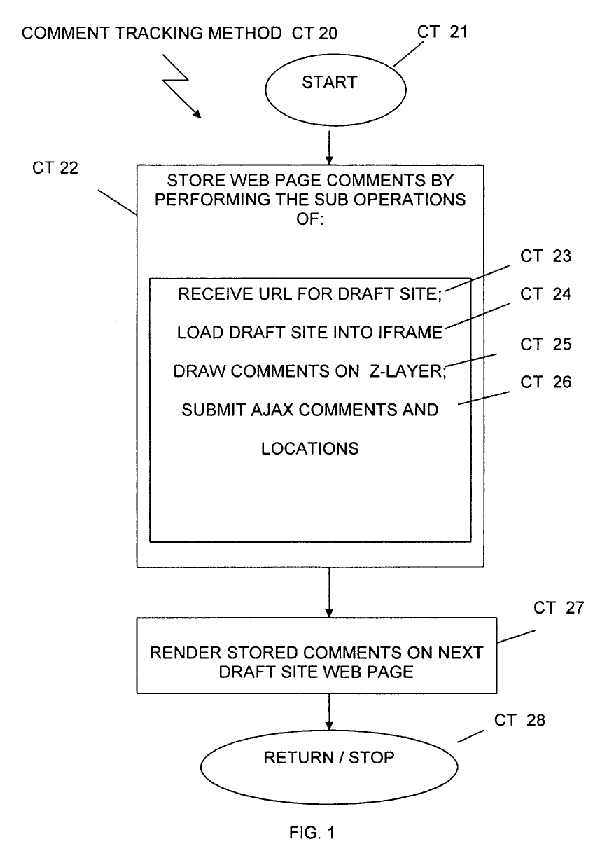

FIG. 1 illustrates an operation for carrying out an exemplary embodiment of efficiently tracking web page comments using visual and graphical user interfaces.

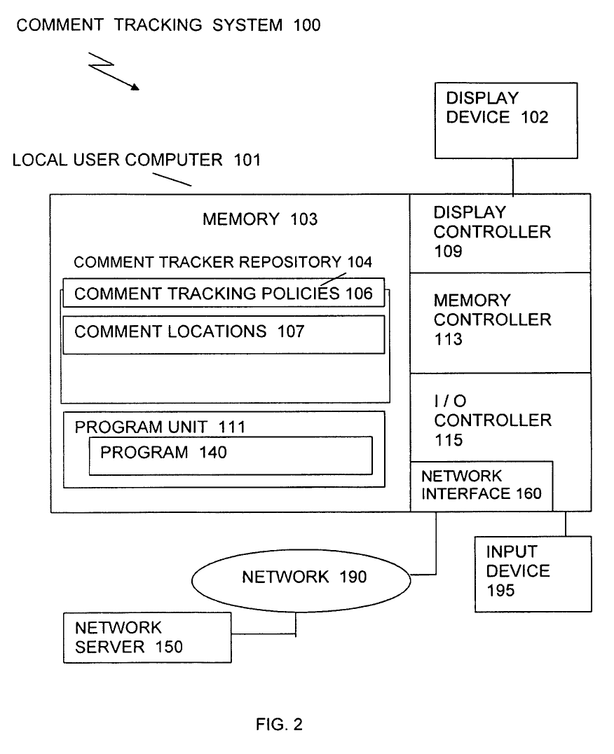

FIG. 2 illustrates the system implementation of the exemplary embodiment of efficiently tracking web page comments using visual and graphical user interfaces.

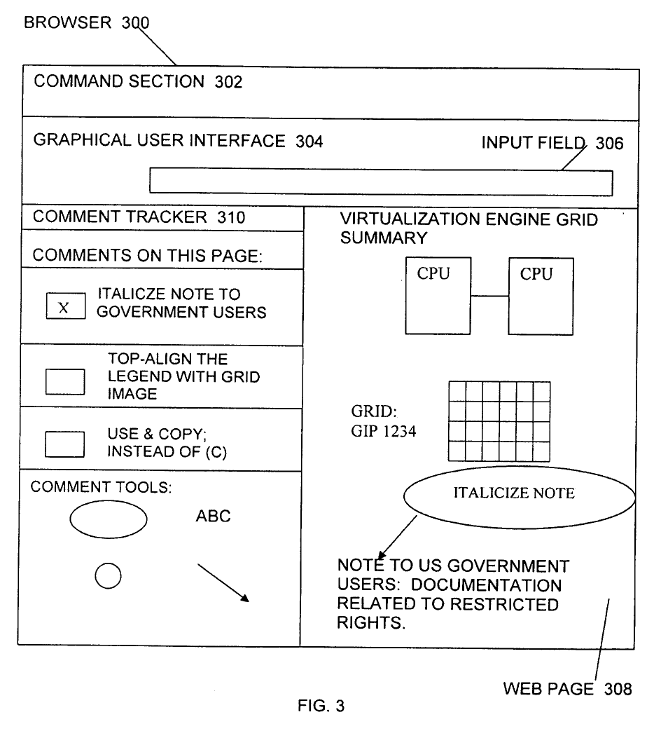

FIG. 3 illustrates the implementation of the exemplary embodiment of efficiently tracking web page comments using a graphical user interface in a web browsers.

### DETAILED DESCRIPTION

The exemplary embodiment of the invention is described below in detail. The disclosed exemplary embodiment is intended to be illustrative only, since numerous modifications and variations therein will be apparent to those of ordinary skill in the art. In reference to the drawings, like numbers will indicate like parts continuously throughout the view. Further, the terms “a”, “an”, “first”, “second” and “third” herein do not denote a limitation of quantity, but rather denote the presence of one or more of the referenced item.

The exemplary embodiment will be understood by referring to FIGS. 1-3. A process of storing web page comments, i.e., comment tracking operation CT 20 is illustrated in FIG. 1. Further, the comment tracking system 100, is illustrated in FIG. 2; and an implementation of the exemplary embodiment of efficiently tracking web comments using visual and graphical user interfaces in a web browser is illustrated in FIG. 3.

Referring to FIG. 2, the comment tracking system 100 (hereafter system 100) includes local user computer 100 connected over network 190 to network server 150. Network 190 can be a wired and/or a wireless local area network or a wide area network, including an extranet or the Internet. Local computer 101 includes at least an input device 195 a display device 102, a network interface 160 and an assortment of internal and external controllers and/or peripheral devices including display controller 109, memory controller 113 and input/output (I/O) controller 115. The network interface 160 can be, for example but not limited to, one or more buses or other wired or wireless connections, as known in the art. The network interface 160 may have additional elements, which are omitted for simplicity, such as controllers, buffers (caches), drivers, repeaters, and receivers, to enable communications. Further, the network interface 160 may include address, control, and/or data connections to enable appropriate communications among the aforementioned components.

Referring to FIG. 2 and FIG. 3, browser 300 is illustrated in FIG. 3 and contains command section 302, graphical user interface 304, input field 306, comment tracker 310 and web page 308, which includes a comment tracker 310 “ITALICIZE NOTE” reminding the user to italicize the note to US Government users, that the document at issue is related to restricted rights. Browser 300 can be downloaded from network server 150 and displayed on display device 102 and accessed by a user using local user computer 101 using input device 195, illustrated in FIG. 2.

Again referring to FIG. 2, input device 195 can include a mouse, a keyboard, a touch screen, a light pen. Local user computer 101 also includes memory 103. Residing in memory 103 is program unit 111, which contains program 140. Also, residing in memory is comment tracker repository 104, which includes one or more comment tools 105, one or more comment tracking policies 106 and a plurality of comment locations 107. Program 140, comment tools 105, and comment tracking policies 106 can include any computer executable program code or algorithm or application software that can be stored on a computer executable medium, including memory 103 and can be compiled, called and run on a general purpose computer processor, or stand alone computing system such as local computer 101, so as to cause local computer 101 to perform certain operations and sub operations.

The memory 103 can include any one or combinations of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge or cassette). Moreover, the memory 103 may incorporate electronic, magnetic, optical, and/or other types of storage media. Note that the memory 103 can have a distributed architecture, where various components are situated remotely from one another, but can be accessed by the local computer 101 and/or network server 150.

Referring to FIGS. 1 and 2, the exemplary embodiment of the comment tracking method CT 20, illustrated in FIG. 1 will be described as implemented in system 100, which is illustrated in FIG. 2. Computer executable code in program 140 when executed by local computer 101, causes local computer 101 to perform the operation start CT 21, to initiate the local computer 101 to perform the operations of comment tracking method CT 20.

The tracking of web page comments can involve an initial web site design phase, as well as a final review phase, which can further include making editorial remarks, as well as, including notations about web page development bugs. The tracking can also be used by students to draft comments on a web page that they are browsing to identify research topics for a school research paper. The tracking of web page comments can further be used in interactive social networking web sites, an example of which is MYSPACE to allow people to make free-hand comments on a page instead of just adding comments to a database. Ultimately, the tracking of web page comments capability can be a web plug in tool that gives people the freedom to make comments and add a plurality of content to web pages. The tracking is accomplished by storing comments on a web page and rendering the stored comments on a next draft site web page, in accordance with stored comment tracking policies, when the next draft site web page is loaded. Thus, there are two web applications, one that is managing the comments (i.e., the application site) and one that is being commented on (i.e., the draft site). These two applications may or may not be on the same machine or the same application.

At operation store web page comments CT 22, program 140, when executed by local user computer 101, causes local user computer 101 to store web page comments by performing the sub operations CT 23 through CT 26 to track and document comments on web page 308 associated with graphical user interface 304 in browser 300 as displayed on display device 102 and accessed by a user of the local user computer 101 in the networked computer system 100. Storing the comments on the web page can include receiving a log on request to an application web site from a local user computer. After receiving the log on request, then logging the local user computer onto the application web site.

At sub operation receive URL for draft site CT 23, program 140, when executed causes local user computer 101 to receive a uniform resource locator (URL) which provides access of the local user computer 101 to a draft web site. The URL can be input into local user computer 101 by input device 195 or the URL can be transmitted from the network server 150 over network 190 and received by the local user computer 101.

At sub operation load draft site into IFRAME CT 24, program 140 causes local user computer 101 to load the draft web site into an inline frame object on the application web site and the content of the draft web site is loaded into a portion of the application web site.

Referring to FIGS. 1 and 2, at sub operation draw comments on Z-LAYER CT 25, program 140 causes local user computer 101 to write the web page comments to a Z-LAYER on top of a page of the drawn draft web site, by the application web site, using a prototype-based scripting language or program for web development. Other examples of such web page comments include but are not limited to comments made by students marking up a web page for research projects or individuals browsing interactive social networking web pages, as well as, web page test and development comments in regard to known bugs. No matter what the implementation is, the comments are inputted onto a Z-LAYER on top of a page of the drawn draft web site, by the application web site, using but not limited to JavaScript or asynchronous JAVASCRIPT and XML (AJAX) comments along with address locations of the comments or any other scripting language or program, implemented by the application web site.

At sub operation, submit AJAX comments and locations CT 26, program 140 causes local user computer 101 to submit the web page comments back to the network server 150 or any number of servers or any number of client side devices or via an application focused on a server as a series of HTTP transactions initiated by a client side script or plugin for a web browser such as, but not limited to FIREFOX. In addition, the implementation can be run on a third party application on a desktop involving databases where the current application is synchronized with other databases or run locally. Furthermore, the application web site has a persistent backup storage capability manifested by comment locations 107, residing in comment tracker repository 104, for storing each comment including text, pixel location and web address and each comment summarized and/or identified by a location address.

Referring to FIGS. 1, 2 and 3, at operation render stored comments CT 27, program 140 causes local user computer 101 to draw the stored comments on the next draft web page, as indicated in web page 308, illustrated in FIG. 3. The comments can be a free-hand rendering in one or more fonts, such as but not limited to cursive of Times New Roman or Arial or script and can include one or more text effects, such as, but not limited to underlining, bold and italicized.

At any stage of the comment tracking method CT 20, the operations of method CT 20 can be directed to operation return/stop CT 28 by program 140, where the comment tools 105 or the comment tracking policies 106 or the comment locations 107 or the program 140 can be updated or additional iterations of any given operation or sub operation can be performed or the method CT 28 can be directed to stop when it is determined by program 140 that all iterations of the method CT 28 are complete.

Thus, the useful, practical and concrete result of tracking web page comments is accomplished by the inventive design of having two web applications, one that is managing the comments (i.e., the application site) and one that is being commented on (i.e., the draft site).

The disclosure has been described with reference to the exemplary embodiment, where for example, an external application marks up an existing web site without interfering with or having to update the code of the existing website.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

In addition, many modifications may be made to adapt a particular situation or material to the teachings of the disclosure without departing from the essential scope thereof. For example, the operations and sub operations of updating and performing additional iterations at method CT 28 can be carried out by at least polling and/or interrupt operations. It will be understood by those skilled in the art that various changes may be made and equivalents may be substituted for elements thereof without departing from the scope of the disclosure. Therefore, it is intended that the disclosure not be limited to any one particular embodiment disclosed as the best mode contemplated for carrying out this disclosure, but that the disclosure will include all embodiments falling within the scope of the appended claims.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

In addition, many modifications may be made to adapt a particular situation or material to the teachings of the disclosure without departing from the essential scope thereof. It will be understood by those skilled in the art that various changes may be made and equivalents may be substituted for elements thereof without departing from the scope of the disclosure. Therefore, it is intended that the disclosure not be limited to any one particular embodiment disclosed as the best mode contemplated for carrying out this disclosure, but that the disclosure will include all embodiments falling within the scope of the appended claims.

What is claimed is:

1. A method, implemented in a computer system, of tracking and documenting comments on a web page in a graphical user interface of a local computer of the computer system, wherein the local computer includes a computer readable storage medium containing computer executable code that when executed by the local computer causes the local computer to perform the method comprising:
storing comments on the web page by:
receiving a uniform resource locator to a draft web site, wherein the uniform resource locator is input from an input device on the local user computer, and wherein the draft web site includes a plurality of content;
loading the draft web site into an inline frame object on an application web site and loading the plurality of content of the draft web site into a portion of the application web site;
drawing comments on a z-layer on top of a page of the drawn draft web site, by the application web site, using a scripting language; implemented by the application web site, in accordance with stored comment tracking policies; and
submitting the scripting language comments and submitting locations of the scripting language comments back to a server, wherein the scripting language includes one or more of JAVASCRIPT, XML, asynchronous JAVASCRIPT and XML; and
rendering the stored comments on a next draft site web page, when the next draft site web page is loaded, wherein the application web site manages comments on the next draft web site, wherein the managed comments are used for one or more of tracking known web page development bugs, tracking research topics and adding free-hand content in interactive social networking web pages.

2. The method of claim 1, wherein the application web site has a backup storage capacity for each comment including text, pixel location and web addresses, wherein each comment is summarized by an address.

3. The method of claim 1, wherein the web browser includes a plugin to execute the client side scripting.

4. A computer system, tracks and documents comments on a web page, the system comprising:
a network server and a local user computer are connected over a network; wherein the local user computer contains a memory, an input device, a network interface, an input/output controller, memory controller a display controller and a display device which displays a graphical user interface, wherein the memory includes a comment tracker repository which includes one or more comment tools, one or more comment tracking policies and one or more locations of script language comments tracked;
residing in memory is a program unit containing computer executable program code that when executed by the local computer causes the local computer to perform a method comprising:
receiving a signal from the network server causing the local computer to store comments on the web page by:
receiving a uniform resource locator to a draft web site generated by the network server, wherein the uniform resource locator is input from an input device on the local user computer, and wherein the draft web site includes a plurality of content;
loading the draft web site into an inline frame object on an application web site and loading the plurality of content of the draft web site into a portion of the application web site;
drawing comments on a z-layer on top of a page of the drawn draft web site, by the application web site, using a scripting language implemented by the application web site, in accordance with stored comment tracking policies; and
submitting the scripting language comments and submitting locations of the scripting language comments back to the network server, wherein the scripting language includes one or more of JAVASCRIPT, XML asynchronous JAVASCRIPT and XML; and
rendering the stored comments on a next draft site web page, when the next draft site web page is loaded onto the web browser by the network server, wherein the application web site manages comments on the next draft web site, wherein the managed comments are used for one or more of tracking known web page development bugs, tracking research topics and adding free-hand content in interactive social networking web pages.

5. The computer system of claim 4, wherein the application web site has a backup storage capacity for each comment including text, pixel location and web addresses, wherein each comment is summarized by an address.

6. The computer system of claim 4, wherein the web browser includes a plugin to execute the client side scripting.
